(19) United States
(12) Patent Application Publication
(10) Pub. No.: US 2026/0312298 A1
(43) Pub. Date: Oct. 8, 2026

(54) ANTENNA SUBSTRATE

(71) Applicant: Fujikura Ltd., Tokyo (JP)

(72) Inventor: Yuta Hasegawa, Sakura-shi (JP)

(73) Assignee: Fujikura Ltd., Tokyo (JP)

(21) Appl. No.: 19/482,285

(22) PCT Filed: Apr. 19, 2024
(86) PCT No.: PCT/JP2024/015555

§ 371 Date: Nov. 7, 2025

(30) Foreign Application Priority Data
May 12, 2023 (JP) 2023-079034

(51) Int. Cl. H01Q 21/24; H01Q 1/22; H01Q 1/38; H01Q 1/52; H01Q 9/04; H01Q 21/06; H01Q 23/00

(52) U.S. Cl. CPC H01Q 21/24; H01Q 1/2283; H01Q 1/38; H01Q 1/523; H01Q 9/04; H01Q 21/061; H01Q 23/00

(57) ABSTRACT

According to the present invention, an antenna substrate includes a core layer, a first buildup layer laminated on one surface of the core layer and a second buildup layer laminated on the other surface of the core layer. An antenna is formed on the first buildup layer. A high-frequency integrated circuit (IC) is mounted on the second buildup layer. A ground layer formed away from the antenna in a thickness direction and a power supply wiring layer formed on an opposite side of the antenna with respect to the ground layer in the thickness direction are provided in an inner layer of the core layer. The core layer includes a first through-hole via configured to pass through the core layer in the thickness direction from the one surface to the other surface and electrically connect the power supply wiring layer and the high-frequency integrated circuit (IC).

### TECHNICAL FIELD

The present invention relates to an antenna substrate.

Priority is claimed on Japanese Patent Application No. 2023-079034 filed May 12, 2023, the content of which is incorporated herein by reference.

### BACKGROUND ART

The following Patent Document 1 discloses an antenna substrate in which a ground conductor is formed on one main surface of a core insulating plate, buildup insulating layers and buildup wiring layers are alternately laminated on a surface containing the ground conductor, and an antenna pad is provided on the other main surface of the core insulating plate.

### CITATION LIST

### Patent Document

Patent Document 1: Japanese Patent No. 5955215

### SUMMARY OF INVENTION

### Technical Problem

A high-frequency integrated circuit (IC) (radio-frequency integrated circuit (RFIC)) may be mounted on an antenna substrate for performing high-frequency communication using a millimeter wave band or the like. In this case, it is necessary to form a large number of signal lines such as a signal line through which a high-frequency signal passes, power supply wiring for a high-frequency IC, and digital wiring for controlling an amplifier gain and a phase shifter in a buildup layer of an antenna substrate and the number of buildup layers increases. When the number of buildup layers increases, the manufacturing cost of the antenna substrate may increase and the reliability of the antenna substrate due to the accumulation of dimensional errors associated with the lamination of the buildup layers may decrease.

The present invention has been made in consideration of the above problems, and an objective of the present invention is to ensure a thickness between an antenna and a ground layer while reducing the number of buildup layers in an antenna substrate on which a high-frequency IC is mounted.

### Solution to Problem

According to a first aspect of the present invention, there is provided an antenna substrate including: a core layer having a plurality of conductor layers; a first buildup layer laminated on one surface of the core layer; and a second buildup layer laminated on the other surface of the core layer; wherein an antenna is formed on the first buildup layer, wherein a high-frequency IC electrically or electromagnetically connected to the antenna is mounted on the second buildup layer, wherein a ground layer formed away from the antenna in a thickness direction and a power supply wiring layer formed on an opposite side of the antenna with respect to the ground layer in the thickness direction are provided in an inner layer of the core layer, and wherein the core layer includes a first through-hole via configured to pass through the core layer in the thickness direction from the one surface to the other surface and electrically connect the power supply wiring layer and the high-frequency IC.

According to the first aspect of the present invention, the power supply wiring layer that supplies electric power to the high-frequency IC is provided in the inner layer of the core layer. Thereby, the number of buildup layers (second buildup layers) can be reduced. Moreover, the ground layer is provided inside the core layer, and the power-supply wiring layer is arranged on the opposite side of the antenna with respect to the ground layer. Thereby, electromagnetic wave leakage from the antenna to the power-supply wiring layer can be suppressed. In this structure, an electrical connection between the high-frequency IC and the power supply wiring layer is ensured by the first through-hole via passing through the core layer in the thickness direction. Thus, it is possible to improve the reliability of the antenna substrate and reduce manufacturing costs.

According to a second aspect of the present invention, in the antenna substrate according to the first aspect, the first buildup layer includes a conductive frame body surrounding the antenna in a plan view viewed from the thickness direction, the frame body is electrically connected to the ground layer by a plurality of second through-hole vias arranged at a position overlapping the frame body in the plan view viewed from the thickness direction and configured to pass through the core layer, and the first through-hole via is arranged inside the frame body in the plan view viewed from the thickness direction.

According to a third aspect of the present invention, in the antenna substrate according to the first aspect, the first buildup layer includes a conductive frame body surrounding the antenna in a plan view viewed from the thickness direction, the frame body is electrically connected to the ground layer by a plurality of second through-hole vias arranged at a position overlapping the frame body in the plan view viewed from the thickness direction and configured to pass through the core layer, and the first through-hole via is arranged at a position overlapping the frame body in the plan view viewed from the thickness direction.

According to a fourth aspect of the present invention, in the antenna substrate according to any one of the first to third aspects, the antenna includes a first antenna extending in a first direction along the first buildup layer; and a second antenna arranged at a position different from that of the first antenna in the thickness direction and extending in a second direction intersecting the first antenna, and the first through-hole via is arranged at a position retracted from a position overlapping the first antenna and the second antenna and a position retracted from an extension line of the first antenna and the second antenna in a plan view viewed from the thickness direction.

According to a fifth aspect of the present invention, in the antenna substrate according to any one of the first to fourth aspects, an effective length between the antenna and the ground layer in the thickness direction is within a range of 1/10 to ½ of a wavelength of a center frequency of a frequency band received or transmitted by the antenna.

According to a sixth aspect of the present invention, in the antenna substrate according to any one of the first to fourth aspects, an effective length between the antenna and the ground layer in the thickness direction is within a range of ⅛ to ⅜ of a wavelength of a center frequency of a frequency band received or transmitted by the antenna.

According to a seventh aspect of the present invention, in the antenna substrate according to any one of the first to sixth aspects, a plurality of the antennas are formed in an array shape on the first buildup layer, and the first through-hole vin is arranged in at least one of antenna formation areas in a plan view viewed from the thickness direction.

### Advantageous Effects of Invention

According to the above-described aspect of the present invention, it is possible to ensure a thickness between the antenna and the ground layer while reducing the number of buildup layers of the antenna substrate on which the high-frequency IC is mounted.

### BRIEF DESCRIPTION OF DRAWINGS

FIG. 1 A plan view of an antenna substrate according to an embodiment.

FIG. 2 A plan view of an antenna formation area according to the embodiment.

FIG. 3 A cross-sectional view taken along III-III shown in FIG. 2.

FIG. 4 A cross-sectional view taken along IV-IV shown in FIG. 2.

FIG. 5 A cross-sectional view taken along V-V shown in FIG. 2.

FIG. 6 A plan view of an antenna formation area of an antenna substrate according to a comparative example.

FIG. 7 A graph showing antenna characteristics of the antenna formation area of the antenna substrate according to the comparative example,

FIG. 8 A graph showing antenna characteristics of an antenna formation area according to a first example.

FIG. 9 A plan view of an antenna formation area of an antenna substrate according to a second example.

FIG. 10 A graph showing antenna characteristics of the antenna formation area according to the second example.

FIG. 11 A plan view of an antenna formation area of an antenna substrate according to a third example.

FIG. 12 A graph showing antenna characteristics of the antenna formation area according to the third example.

### DESCRIPTION OF EMBODIMENTS

Hereinafter, an antenna substrate according to an embodiment of the present invention will be described with reference to the drawings.

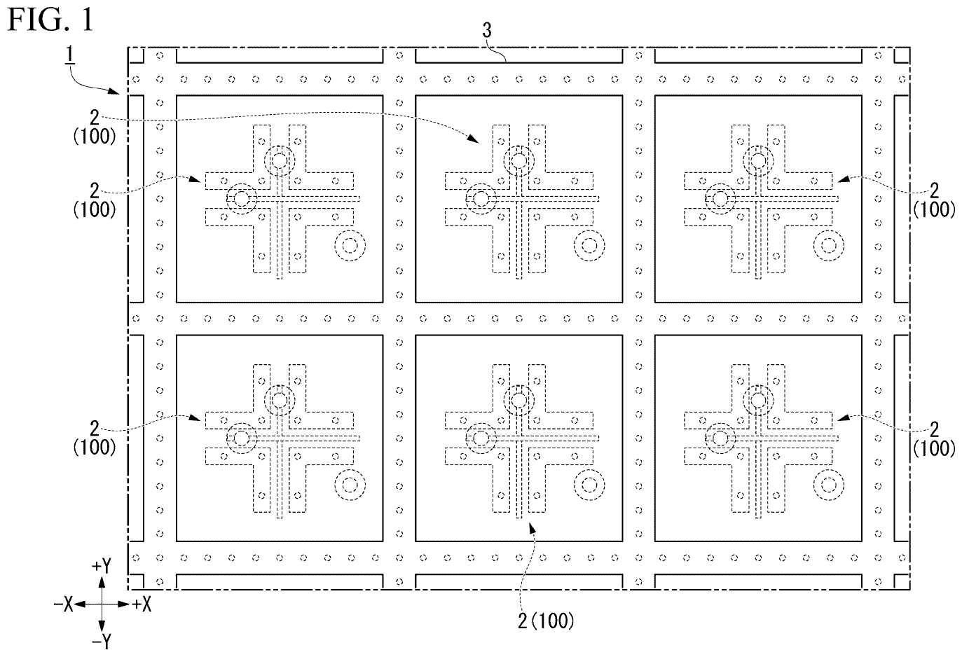

FIG. 1 is a plan view of an antenna substrate 1 according to an embodiment.

The antenna substrate 1 shown in FIG. 1 includes a plurality of antenna formation areas 100, wherein an antenna 2 is formed in each antenna formation area 100. The plurality of antenna formation areas 100 are arranged two-dimensionally and a plurality of antennas 2 form an array antenna. A conductive frame body 3 extending in a grid pattern is arranged on a boundary line between the antenna formation areas 100.

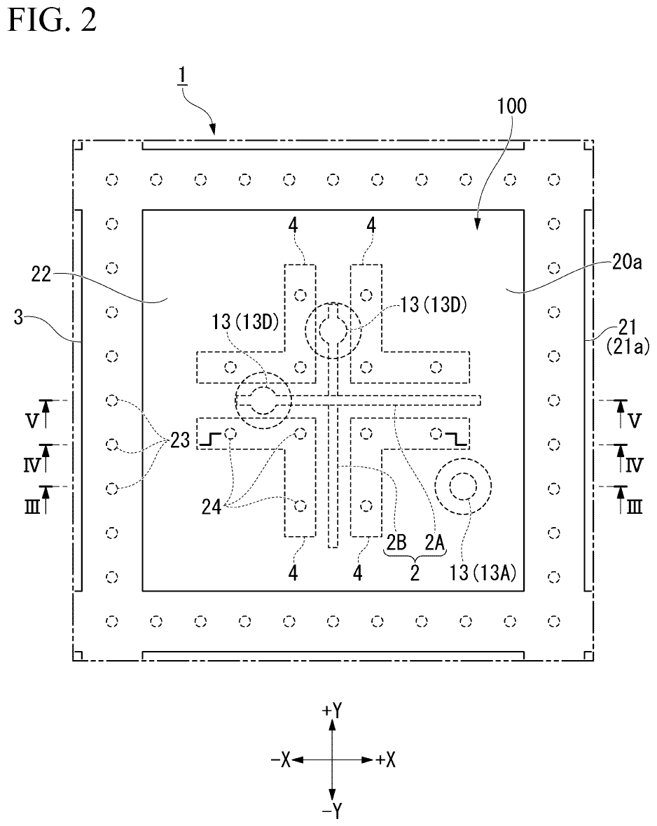

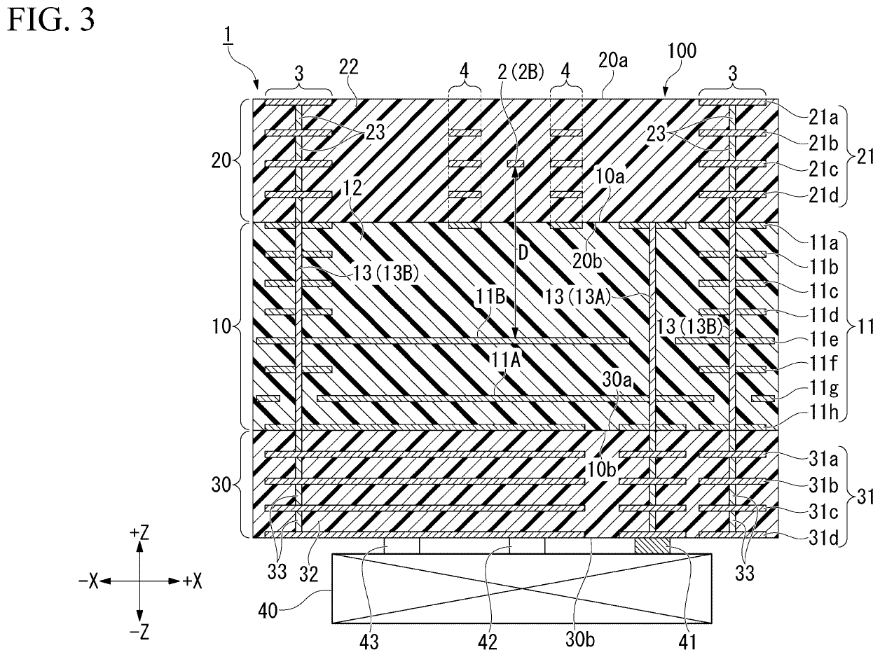

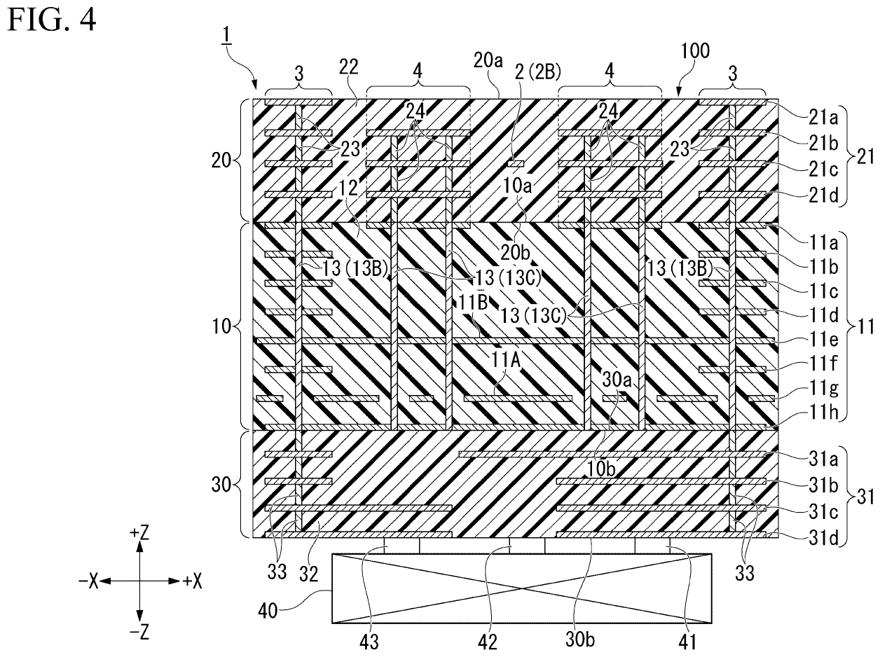

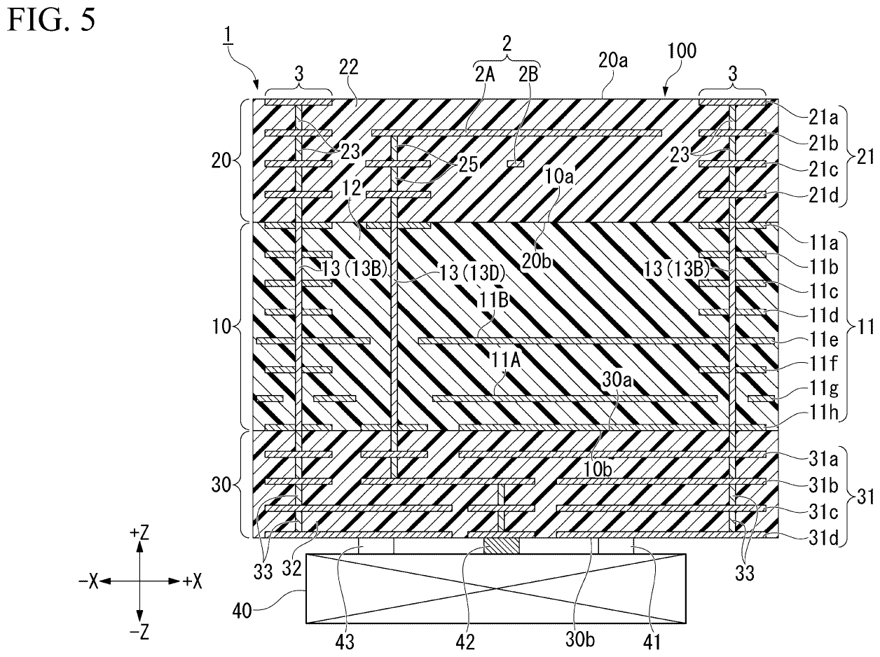

FIG. 2 is a plan view of the antenna formation area 100 according to the embodiment. FIG. 3 is a cross-sectional view taken along III-III shown in FIG. 2. FIG. 4 is a cross-sectional view taken along IV-IV shown in FIG. 2. FIG. 5 is a cross-sectional view taken along V-V shown in FIG. 2.

As shown in FIGS. 3 to 5, the antenna substrate 1 includes a core layer 10 having a plurality of conductor layers 11, a first buildup layer 20 laminated on one surface 10a of the core layer 10, and a second buildup layer 30 laminated on the other surface 10b of the core layer 10.

In the following description, an XYZ Cartesian coordinate system is set. A positional relationship between members may be described with reference to this XYZ Cartesian coordinate system. As shown in FIGS. 3 to 5, a Z-axis direction is set as the thickness direction of the antenna substrate 1. Hereinafter, the first buildup layer 20 side relative to the core layer 10 will be referred to as an upper side or a +Z side, and the second buildup layer side relative to the core layer 10 will be referred to as a lower side or a −Z side. In addition, the +Z side may not be the upper side in a direction of gravity.

Viewing the antenna substrate 1 from the thickness direction (Z-axis direction) is referred to as a plan view. An X-axis direction is a first direction perpendicular to the thickness direction. In addition, to distinguish between directions along an X-axis, they may be referred to as a +X side (right side) and a −X side (left side). The Y-axis direction is a second direction perpendicular to the thickness direction and the first direction. In addition, to distinguish between directions along a Y-axis, they may be referred to as a +Y side (rear side) and a −Y side (front side). As shown in FIG. 2, the frame body 3 extends in the first direction (X-axis direction) and the second direction (Y-axis direction).

As shown in FIG. 3, a plurality of conductor layers 21 are provided in the first buildup layer 20. An insulating layer 22 is provided in each of gaps between the plurality of conductor layers 21 to fill each of the gaps between the plurality of conductor layers 21. In other words, the first buildup layer 20 is formed by alternately laminating the insulating layers 22 and the conductor layers 21 on one surface 10a (upper surface) of the core layer 10.

The plurality of conductor layers 21 form the antenna 2, the frame body 3, and the ground pattern 4. Four conductor layers 21a to 21d arranged in order from an upper surface 20a to a lower surface 20b of the first buildup layer 20 as the conductor layers 21 are provided in the first buildup layer 20. In addition, the number of conductor layers 21 is merely an example and is not limited to four.

As shown in FIG. 2, the antenna 2 includes a first antenna 2A and a second antenna 2B intersecting in a crisscross pattern in the plan view. The first antenna 2A and the second antenna 2B intersect at a center position of the antenna formation area 100 in the plan view. In addition, one of the first antenna 2A and the second antenna 2B is an antenna for V-polarized waves and the other is an antenna for H-polarized waves.

The first antenna 2A and the second antenna 2B have flat-plate patterns formed from a conductor and are configured to transmit and receive high-frequency radio signals (e.g., in a 28 GHz band). In addition, the first antenna 2A and the second antenna 2B may be configured to only transmit or only receive high-frequency radio signals.

The first antenna 2A extends linearly in the first direction (X-axis direction) along the surface of the first buildup layer 20. As shown in FIG. 5, the first antenna 2A is formed on the conductor layer 21b that is an inner layer of the first buildup layer 20. In other words, the first antenna 2A is embedded in the first buildup layer 20.

As shown in FIG. 2, the second antenna 2B extends linearly along the surface of the first buildup layer 20 in the second direction (Y-axis direction) intersecting the first antenna 2A. As shown in FIGS. 3 to 5, the second antenna 2B is formed on a conductor layer 21c that is an inner layer of the first buildup layer 20. In other words, the second antenna 2B is embedded below (on the −Z side of) the first antenna 2A in the first buildup layer 20.

As shown in FIG. 2, four ground patterns 4 are formed around the antenna 2. The four ground patterns 4 are arranged along the crisscrossing antenna 2 in the plan view. Bach of the four ground patterns 4 is formed in an L-shape in the plan view and its bent portion is arranged to face the center position of the antenna formation area 100. In other words, the bent portion of the ground pattern 4 is bent to protrude toward the center position of the antenna formation area 100.

In other words, a cross-shaped slit is formed between the four L-shaped ground patterns 4. The antenna 2 is arranged in this cross-shaped slit. The antenna 2 and the ground patterns 4 form a coplanar waveguide. Therefore, when a high-frequency signal is input to the antenna 2, excitation occurs between the antenna 2 and the ground patterns 4, and electromagnetic waves are externally radiated.

As shown in FIGS. 3 to 5, the ground patterns 4 are formed on the conductor layers 21b to 21d, which are inner layers of the first buildup layer 20. In other words, the ground patterns 4 are embedded in a layer identical to a layer in which at least the first antenna 2A and the second antenna 2B are formed in the first buildup layer 20.

As shown in FIG. 4, the ground pattern 4 of each of the conductor layers 21b to 21d is electrically connected in the thickness direction by a plurality of embedded vias 24. In the plan view shown in FIG. 2, the three embedded vias 24 are arranged to overlap the L-shaped ground pattern 4 and are connected to three locations that are one end portion, a bent portion, and the other end portion of the L-shaped ground pattern 4.

As shown in FIGS. 3 to 5, each of the conductor layers 21a to 21d forms the frame body 3. The frame body 3 of each of the conductor layers 21a to 21d is electrically connected in the thickness direction by a plurality of embedded vias 23. In the plan view shown in FIG. 2, the plurality of embedded vias 23 are arranged to overlap the grid-shaped frame body 3 and are connected at predetermined intervals along the frame body 3.

As shown in FIG. 3, a plurality of conductor layers 31 are provided in the second buildup layer 30. An insulating layer 32 is provided in each of the gaps between the plurality of conductor layers 31 to fill each of the gaps between the plurality of conductor layers 31. In other words, the second buildup layer 30 is formed on the other surface 10b (lower surface) of the core layer 10 and is formed by alternately laminating the insulating layers 32 and the conductor layers 31.

Four conductor layers 31a to 31d arranged in order from an upper surface 30a to a lower surface 30b of the second buildup layer 30 as the conductor layers 31 are provided in the second buildup layer 30. In addition, the number of conductor layers 31 is merely an example and is not limited to four.

Wiring necessary for mounting the high-frequency IC 40, such as power-suppl wiring electrically connected to the power supply wiring layer 11A to be described below, signal lines through which high-frequency signals pass, and digital wiring for controlling an amplifier gain and a phase shifter and the like, are formed in the four conductor layers 31a to 31d. A predetermined portion of each of the conductor layers 31a to 31d is connected in the thickness direction by an embedded via 33. In addition, some of the signal lines and digital wiring may be formed in the conductor layer 11h to be described below.

The conductor layer 31d is formed on the lower surface 30b of the second buildup layer 30. The high-frequency IC 40 is mounted on the lower surface 30b of the second buildup layer 30. The high-frequency IC 40 has a plurality of terminal portions 41 to 43 electrically connected to the conductor layer 31d. In the present embodiment, for example, the terminal portion 41 is a power supply terminal, the terminal portion 42 is a high-frequency signal terminal, and the terminal portion 43 is a digital signal terminal. In addition, the high-frequency IC 40 may have another terminal.

As shown in FIG. 3, the core layer 10 has a plurality of conductor layers 11. Insulating layer 12 is provided in each of gaps between the plurality of conductor layers 11 to fill each of the gaps between the plurality of conductor layers 11. In this way, the core layer 10 is multilayered. In addition, the core layer 10 includes a multilayer board, the multilayer board is manufactured using prepreg as the core material, and then holes (through holes) are formed all at once in the multilayer board.

Eight conductor layers 11a to 11h arranged in order from one surface 10a to the other surface 10b as the conductor layers 11 are provided in the core layer 10. In addition, the number of conductor layers 11 is merely an example and is not limited to eight. A plurality of through-hole vias 13 configured to pass through the core layer 10 in the thickness direction from one surface 10a to the other surface 10b are provided in the core layer 10.

A power-supply wiring layer 11A configured to supply electric power to the high-frequency IC 40 and an electrically grounded ground layer 11B are provided in the inner layer of the core layer 10. In addition, the inner layers of the core layer 10 refer to conductor layers 11b to 11g, excluding the conductor layer 11a formed on one surface 10a of the core layer 10 and the conductor layer 11h formed on the other surface 10b. In the present embodiment, the ground layer 11B is formed on the conductor layer 11e and the power supply wiring layer 11A is formed on the conductor layer 11g.

As shown in FIG. 3, the ground layer 11B is formed away from the antenna 2 in the thickness direction (Z-axis direction). It is only necessary for an effective length (thickness D×dielectric constant) between the antenna 2 and the ground layer 11B in the thickness direction to be within a range of 1/10 to ½ of a wavelength of the center frequency (e.g., 28 GHz) of the frequency band received or transmitted by the antenna 2.

More preferably, the effective length between the antenna 2 and the ground layer 11B in the thickness direction is within a range of ⅛ to ⅜ of the wavelength of the center frequency of the frequency band received or transmitted by the antenna 2. In this way, antenna performance is improved by making the effective length between the antenna 2 and the ground layer 11B in the thickness direction closer to ¼ of the wavelength of the center frequency of the frequency band received or transmitted by the antenna 2.

The ground layer 11B is arranged to overlap the antenna 2 in the plan view viewed from the thickness direction. The ground layer 11B covers the entire lower side (−Z side) of the antenna 2. As described below, openings are formed at positions where a first through-hole via 13A (see FIG. 3) and a fourth through-hole via 13D (see FIG. 5) passing through the core layer 10 pass in the ground layer 11B.

As shown in FIG. 3, the power supply wiring layer 11A is formed on the opposite side (−Z side) of the antenna 2 with respect to the ground layer 11B in the thickness direction. The core layer 10 includes the first through-hole via 13A that passes through the core layer 10 from one surface 10a to the other surface 10b in the thickness direction (Z-axis direction) and electrically connects the power-supply wiring layer 11A and the high-frequency IC 40. As described above, the first through-hole via 13A is not electrically connected to the ground layer 11B.

The first through-hole via 13A passes through the power supply wiring layer 11A and is electrically connected to the power supply wiring layer 11A. The first through-hole via 13A is electrically connected to the terminal portion 41 that is a power-supply terminal of the high-frequency IC 40 via the plurality of conductor layers 31 and a plurality of embedded vias 33 of the second buildup layer 30. In addition, circular lands are formed around the first through-hole via 13A on one surface 10a and the other surface 10b of the core layer 10.

Moreover, in addition to the first through-hole via 13A, the core layer 10 includes a second through-hole via 13B, a third through-hole via 13C, and a fourth through-hole via 13D. As in the first through-hole via 13A, in the third through-hole via 13C and the fourth through-hole via 13D, circular lands are also formed on both the first surface 10a and the second surface 10b of the core layer 10. In addition, the second through-hole via 13B is connected to the frame body 3, and a circular land is not formed therein.

As shown in FIGS. 3 to 5, the second through-hole via 13B is arranged at a position overlapping the frame body 3 in the plan view viewed from the thickness direction and passes through the core layer 10. The second through-hole via 13B passes through the ground layer 11B and is electrically connected to the ground layer 11B. The second through-hole via 13B electrically connects the frame body 3 and the ground layer 11B via a plurality of embedded vias 23.

As shown in FIG. 4, the third through-hole via 13C is arranged at a position overlapping the ground pattern 4 in the plan view viewed from the thickness direction and passes through the core layer 10. The third through-hole via 13C passes through the ground layer 11B and is electrically connected to the ground layer 11B. The third through-hole via 13C electrically connects the ground pattern 4 and the ground layer 11B via a plurality of embedded vias 24.

As shown in FIG. 5, the fourth through-hole via 13D is arranged at a position overlapping the first antenna 2A and passes through the core layer 10 in the plan view viewed from the thickness direction. The fourth through-hole via 13D passes through an opening of the ground layer 11B and is not electrically connected to the ground layer 11B and the power supply wiring layer 11A.

The fourth through-hole via 13D electrically connects the first antenna 2A and the terminal portion 42, which is a high-frequency signal terminal of the high-frequency IC 40, via the plurality of conductor layers 21 and the plurality of embedded vias 25 of the first buildup layer 20, and further via the plurality of conductor layers 31 and the plurality of embedded vias 33 of the second buildup layer 30. Although not shown, like the first antenna 2A, the second antenna 2B is also electrically connected to the high-frequency IC 40 via the fourth through-hole via 13D separate from the fourth through-hole via 13D of the first antenna 2A.

The antenna substrate 1 configured as described above includes the first through-hole via 13A configured to pass through the core layer 10. Thereby, the power-supply wiring layer 11A formed in the inner layer of the core layer 10 and the high-frequency IC 40 mounted on the lower surface 30b of the second buildup layer 30 can be electrically connected. However, one end of the first through-hole via 13A is formed on the one surface 10a side (antenna 2 side). Therefore, the first through-hole via 13A is arranged as shown in FIG. 2. Thereby, it is possible to reduce an influence on the antenna 2.

As shown in FIG. 2, the first through-hole via 13A is arranged inside the frame body 3 in the plan view viewed from the thickness direction. Moreover, the first through-hole via 13A is arranged at a position retracted from a position overlapping the first antenna 2A and the second antenna 2B and a position retracted from an extension line of the first antenna 2A and the second antenna 2B, in the plan view viewed from the thickness direction.

Specifically, the first through-hole via 13A is arranged in an area of the right side (+X side) and the front side (−Y side) of the antenna 2 in the antenna formation area 100 inside the frame body 3. Specifically, the first through-hole via 13A is arranged on the −Y side of the first antenna 2A and on the +X side of the second antenna 2B, and is arranged farther away from the center of the antenna formation area 100 than the ground pattern 4.

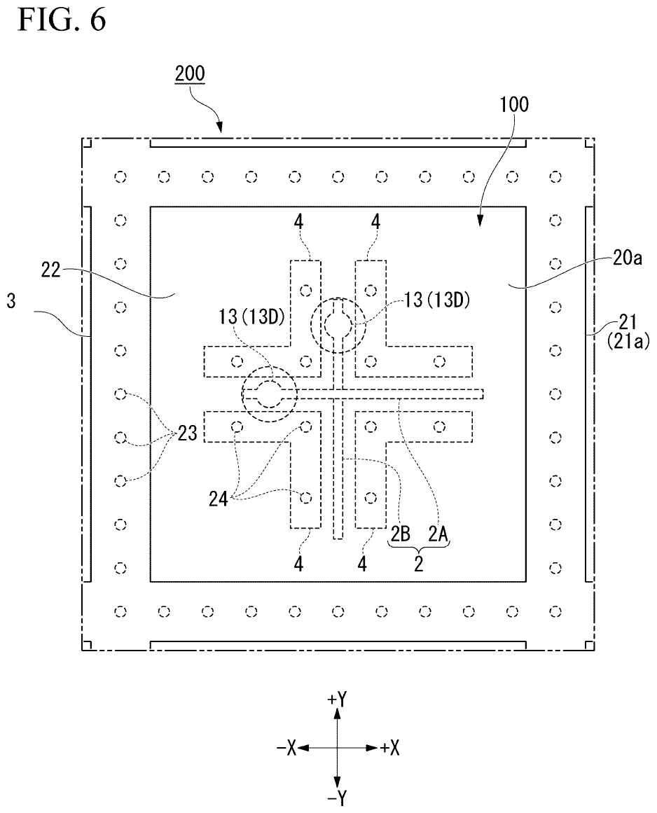

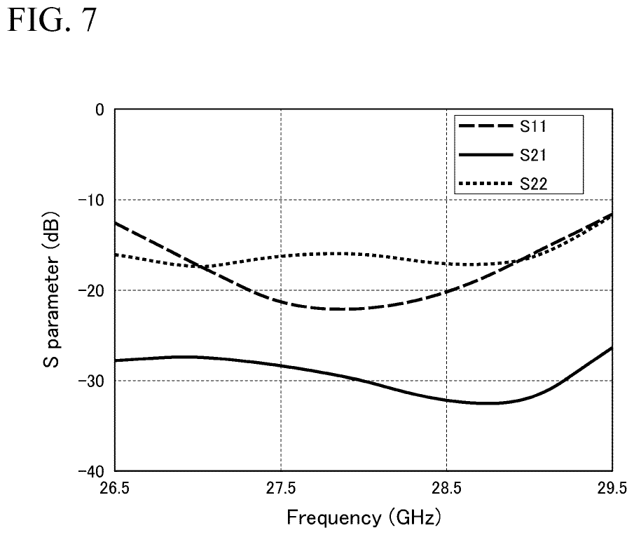

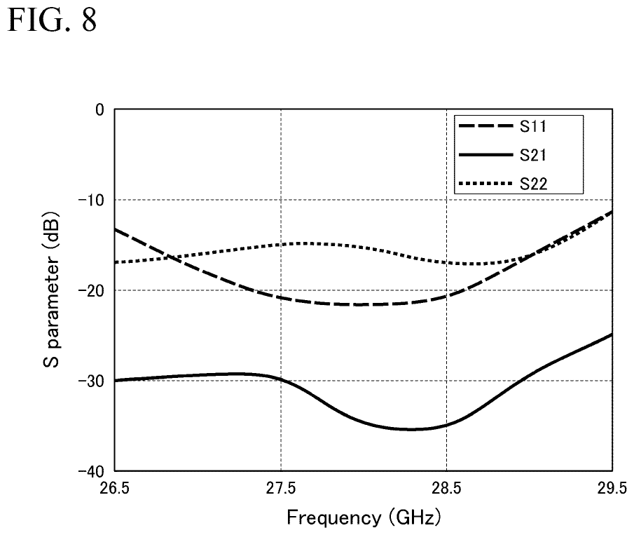

FIG. 6 is a plan view of the antenna formation area 100 of the antenna substrate 200 according to a comparative example. FIG. 7 is a graph showing antenna characteristics of the antenna formation area 100 according to the comparative example. In FIG. 7, the vertical axis represents an S parameter (dB) and the horizontal axis represents a frequency (GHz). “S11” denotes a reflection characteristic of the first antenna 2A. Moreover, “S21” denotes a crosstalk characteristic between the first antenna 2A and the second antenna 2B. Moreover “S22” denotes a reflection characteristic of the second antenna 2B. The terms and symbols used in the graphs in FIGS. 8, 10, and 12 to be described below are similar to those in FIG. 7.

FIG. 8 is a graph showing antenna characteristics of an antenna formation area 100 according to a first example.

As shown in FIG. 6, the antenna substrate 200 according to the comparative example does not have a first through-hole via 13A. The other configuration is the same as that of the antenna substrate 1 according to the first example (see FIG. 2). As shown in FIGS. 7 and 8, when a case where the first through-hole via 13A is not provided (comparative example) is compared with a case where the first through-hole via 13A is provided (first example), it can be seen that there is little change in the S parameters (S11, S21, and S22).

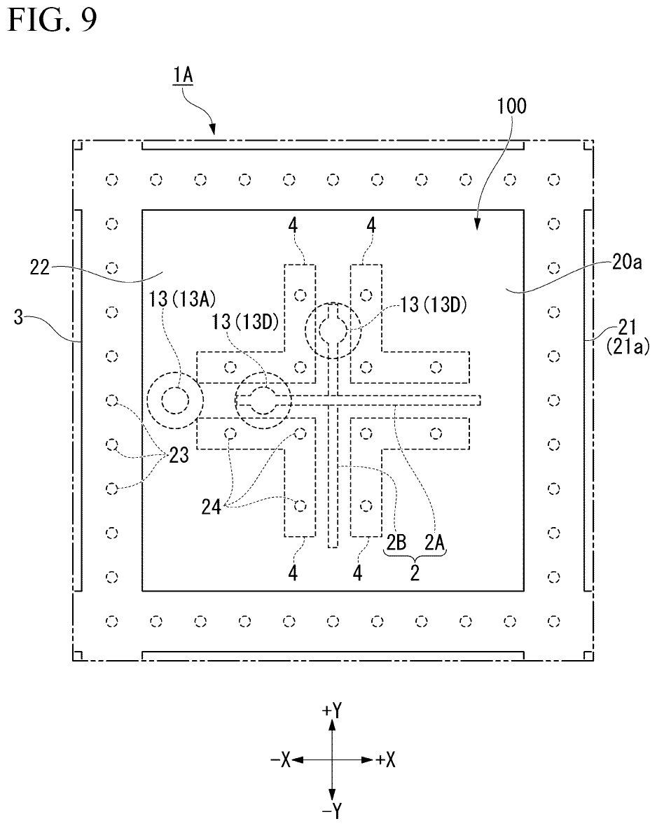

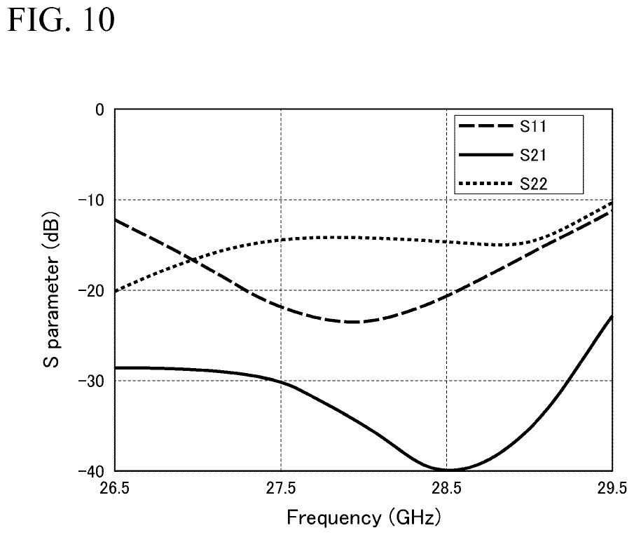

FIG. 9 is a plan view of an antenna formation area 100 of an antenna substrate 1A according to a second example. FIG. 10 is a graph showing antenna characteristics of the antenna formation area 100 according to the second example.

As shown in FIG. 9, in the antenna substrate 1A of the second example, a first through-hole via 13A is arranged at a post on retracted from a position overlapping a first antenna 2A and a second antenna 2B and is arranged on an extension line of the first antenna 2A in the plan view viewed from the thickness direction. In this case, compared to the first example, as shown in FIG. 10, an S parameter (S21) is particularly increased near 29.5 GHZ. Therefore, it can be seen that it is preferable to arrange the first through-hole via 13A at a position retracted from an extension line of the first antenna 2A. In addition, the results are similar to those described above when the first through-hole via 13A is arranged at a position retracted from a position overlapping the first antenna 2A and the second antenna 2B and is arranged on an extension line of the second antenna 2B in the plan view viewed from the thickness direction.

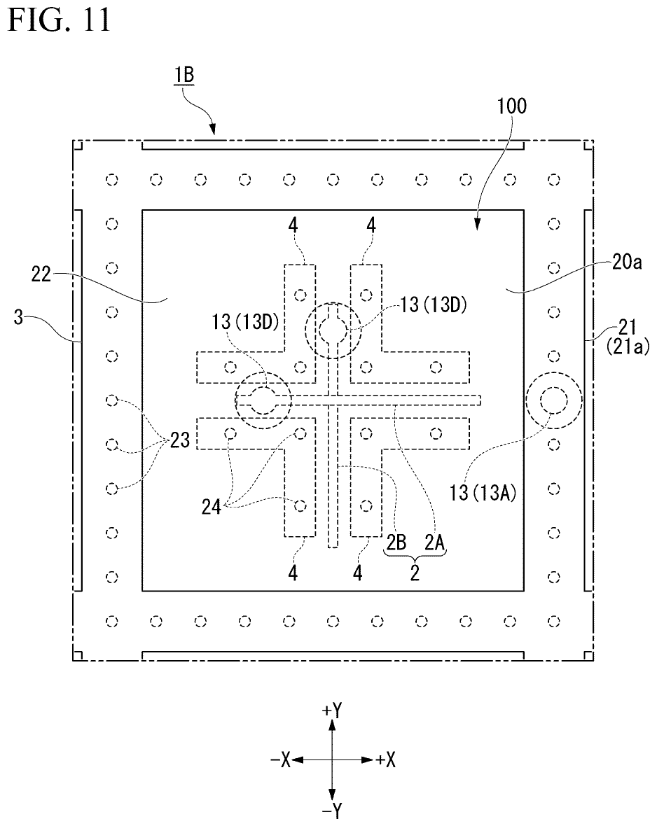

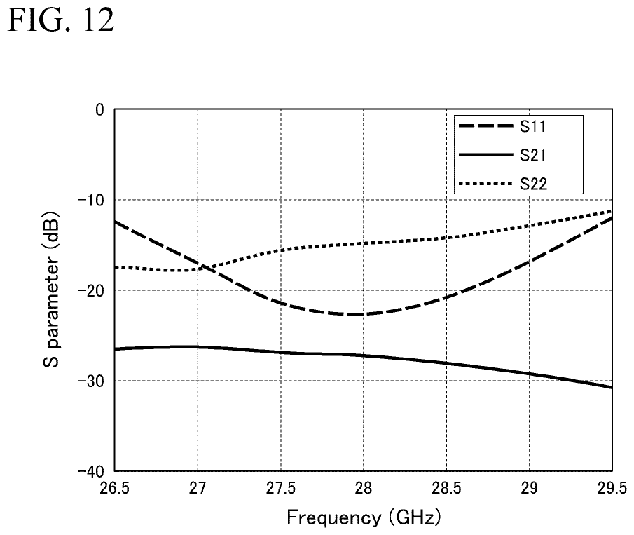

FIG. 11 is a plan view of an antenna formation area 100 of an antenna substrate 1B according to a third example. FIG. 12 is a graph showing antenna characteristics of the antenna formation area 100 according to the third example.

As shown in FIG. 11, in the antenna substrate 1B according to the third example, a first through-hole via 13A is arranged on an extension line of a first antenna 2A and arranged at a position overlapping a frame body 3 in place of one embedded via 23 in the plan view seen from the thickness direction. In this case, compared to the second example, as shown in FIG. 12, an S parameter (S21) near 29.5 GHz is lower than in the second example. Therefore, it can be seen that it is preferable to arrange the first through-hole via 13A at a position overlapping a frame body 3, even if it is on the extension line of the first antenna 2A. Moreover, it is preferable to arrange the first through-hole via 13A at a position overlapping the frame body 3, even if it is not on the extension line of the first antenna 2A. In addition, the results are similar to that of the above case even if the first through-hole via 13A is arranged on the extension line of the second antenna 2B and is arranged at a position overlapping the frame body 3 instead of one embedded via 23 in the plan view viewed from the thickness direction. Moreover, it is preferable to arrange the first through-hole via 13A at a position overlapping the frame body 3, even if it is not on the extension line of the second antenna 2B.

As described above, according to the present embodiment the power supply wiring layer 11A configured to supply electric power to the high-frequency IC 40 is provided in an inner layer of the core layer 10. Accordingly, it is possible to reduce the number of second buildup layers 30. Moreover, the ground layer 11B is provided in the inner layer of the core layer 10, and the power supply wiring layer 11A is arranged on the opposite side of the antenna 2 with respect to the ground layer 11B. Thereby, it is possible to suppress the leakage of electromagnetic waves from the antenna 2 to the power supply wiring layer ILA side. In this structure, the electrical connection between the high-frequency IC 40 and the power supply wiring layer 11A can be ensured by the first through-hole via 13A that passes through the core layer 10 in the thickness direction.

Thereby, it is possible to improve the reliability of the antenna substrate 1 and reduce manufacturing costs.

In this way, according to the present embodiment, the antenna substrate 1 includes the core layer 10 having the plurality of conductor layers 11; the first buildup layer 20 laminated on one surface 10a of the core layer 10; and the second buildup layer 30 laminated on the other surface 10b of the core layer 10; wherein the antenna 2 is formed on the first buildup layer 20, wherein the high-frequency IC 40 electrically or electromagnetically connected to the antenna 2 is mounted on the second buildup layer 30, wherein the ground layer 11B formed away from the antenna 2 in a thickness direction and the power-supply wiring layer 11A formed on an opposite side of the antenna 2 with respect to the ground layer 11B in the thickness direction are provided in an inner layer of the core layer 10, and wherein the core layer 10 includes the first through-hole via 13A configured to pass through the core layer in the thickness direction from the one surface 10a to the other surface 10b and electrically connect the power-supply wiring layer 11A and the high-frequency IC 40. According to this configuration, it is possible to ensure a thickness between the antenna 2 and the ground layer HIB while reducing the number of buildup layers in the antenna substrate 1 on which the high-frequency IC 40 is mounted.

Moreover, in the present embodiment, the first buildup layer 20 includes the conductive frame body 3 surrounding the antenna 2 in the plan view viewed from the thickness direction, the frame body 3 is electrically connected to the ground layer 11B by the plurality of second through-hole vias 13B arranged at a position overlapping the frame body 3 in the plan view viewed from the thickness direction and configured to pass through the core layer 10, and the first through-hole via 13A is arranged inside the frame body 3 in the plan view viewed from the thickness direction. According to this arrangement, as shown in FIGS. 2 and 8, even if the first through-hole via 13A is present, an influence on the antenna 2 is reduced.

Moreover, in the present embodiment, the first buildup layer 20 includes the conductive frame body 3 surrounding the antenna 2 in the plan view viewed from the thickness direction, the frame body 3 is electrically connected to the ground layer 11B by the plurality of second through-hole vias 13B arranged at a position overlapping the frame body 3 in the plan view viewed from the thickness direction and configured to pass through the core layer 10, and the first through-hole via 13A is arranged at a position overlapping the frame body 3 in the plan view viewed from the thickness direction. According to this arrangement, as shown in FIGS. 11 and 12, even if the first through-hole via 13A is present, an influence on the antenna 2 is reduced. In contrast, the S-parameter (S21) decreases near 29.5 GHZ and can improve the antenna characteristics.

Moreover, in the present embodiment, the antenna 2 includes the first antenna 2A extending in a first direction (X direction) along the first buildup layer 20; and the second antenna 2B arranged at a position different from that of the first antenna 2A in the thickness direction (Z direction) and extending in a second direction (Y direction) intersecting the first antenna 2A, and the first through-hole via 13A is arranged at a position retracted from a position overlapping the first antenna 2A and the second antenna 2B and a position retracted from an extension line of the first antenna 2A and the second antenna 2B in the plan view viewed from the thickness direction. According to this arrangement, an influence on the antenna 2 is reduced, as can be seen by comparing FIGS. 2 and 8 with FIGS. 9 and 10.

Moreover, in the present embodiment, an effective length between the antenna 2 and the ground layer 11B in the thickness direction is within a range of 1/10 to ½ of a wavelength of a center frequency of a frequency band received or transmitted by the antenna 2. According to this configuration, the effective length between the antenna 2 and the ground layer 11B in the thickness direction approaches ¼ of the wavelength of the center frequency of the frequency band received or transmitted by the antenna 2. Thus, antenna performance is improved.

Moreover, in the present embodiment, an effective length between the antenna 2 and the ground layer 11B in the thickness direction is within a range of ⅛ to ⅜ of a wavelength of a center frequency of a frequency band received or transmitted by the antenna 2. According to this configuration, the effective length between the antenna 2 and the ground layer 11B in the thickness direction is closer to ¼ of the wavelength of the center frequency of the frequency band received or transmitted by the antenna 2. Thus, antenna performance is further improved.

Moreover, in the present embodiment, the plurality of antennas 2 are formed in an array shape on the first buildup layer 20, and the first through-hole via 13A is arranged in at least one of the antenna formation areas 100 of the antenna 2 in the plan view viewed from the thickness direction. According to this configuration, it is possible to improve the reliability of the array antenna and reduce manufacturing costs. Although the first through-hole vias 13A are provided in all antenna formation areas 100 in the present embodiment, there may be an antenna formation area 100 in which no first through-hole via 13A is provided.

While preferred embodiments of the present invention have been described above, it should be understood that these are examples of the present invention and should not be considered as limiting the present invention. Additions, omissions, substitutions, and other modifications may be made without departing from the scope of the present invention. Accordingly, the present invention should not be construed as being limited by the foregoing description, but rather should be defined by the scope of the claims.

For example, the antenna 2 may be a dual-polarized antenna.

Moreover, the high-frequency IC 40 may be electromagnetically connected to the antenna 2.

Moreover, the antenna substrate 1 may form a phased array antenna.

In addition, within the spirit and scope of the present invention, the constituent elements in the above-described embodiments may be replaced with well-known constituent elements, and the above-described embodiments or modification examples may be combined as appropriate.

### REFERENCE SIGNS LIST

1 Antenna substrate
1A Antenna substrate
1B Antenna substrate
2 Antenna
2A First antenna
2B Second antenna
3 Frame body
4 Ground pattern
10 Core layer
10a One surface
10b Other surface
11 (11a to 11h) Conductor layer
12 Insulating layer
13 Through-hole via
13A First through-hole via
13B Second through-hole via
13C Third through-hole via
13D Fourth through-hole via
20 First buildup layer
20a Upper surface
20b Lower surface
21 (21a to 21d) Conductor layer
22 Insulating layer
23 Embedded via
24 Embedded via
25 Embedded via
30 Second buildup layer
30a Upper surface
30b Lower surface
31 (31a to 31d) Conductor layer
32 Insulating layer
33 Embedded via
40 High-frequency IC
41 Terminal portion
42 Terminal portion
43 Terminal portion
100 Antenna formation area
200 Antenna substrate

1. An antenna substrate comprising:
a core layer having a plurality of conductor layers;
a first buildup layer laminated on one surface of the core layer; and
a second buildup layer laminated on the other surface of the core layer;
wherein an antenna is formed on the first buildup layer,
wherein a high-frequency integrated circuit (IC) electrically or electromagnetically connected to the antenna is mounted on the second buildup layer,
wherein a ground layer formed away from the antenna in a thickness direction and a power-supply wiring layer formed on an opposite side of the antenna with respect to the ground layer in the thickness direction are provided in an inner layer of the core layer, and
wherein the core layer includes a first through-hole via configured to pass through the core layer in the thickness direction from the one surface to the other surface and electrically connect the power-supply wiring layer and the high-frequency IC.

2. The antenna substrate according to claim 1,
wherein the first buildup layer includes a conductive frame body surrounding the antenna in a plan view viewed from the thickness direction,
wherein the frame body is electrically connected to the ground layer by a plurality of second through-hole vias arranged at a position overlapping the frame body in the plan view viewed from the thickness direction and configured to pass through the core layer, and
wherein the first through-hole via is arranged inside the frame body in the plan view viewed from the thickness direction.

3. The antenna substrate according to claim 1,
wherein the first buildup layer includes a conductive frame body surrounding the antenna in a plan view viewed from the thickness direction,
wherein the frame body is electrically connected to the ground layer by a plurality of second through-hole vias arranged at a position overlapping the frame body in the plan view viewed from the thickness direction and configured to pass through the core layer, and
wherein the first through-hole via is arranged at a position overlapping the frame body in the plan view viewed from the thickness direction.

4. The antenna substrate according to claim l,
wherein the antenna includes
a first antenna extending in a first direction along the first buildup layer; and
a second antenna arranged at a position different from that of the first antenna in the thickness direction and extending in a second direction intersecting the first antenna, and
wherein the first through-hole via is arranged at a position retracted from a position overlapping the first antenna and the second antenna and a position retracted from an extension line of the first antenna and the second antenna in a plan view viewed from the thickness direction.

5. The antenna substrate according to claim 1,
wherein an effective length between the antenna and the ground layer in the thickness direction is within a range of 1/10 to ½ of a wavelength of a center frequency of a frequency band received or transmitted by the antenna.

6. The antenna substrate according to claim 1,
wherein an effective length between the antenna and the ground layer in the thickness direction is within a range of ⅛ to ⅜ of a wavelength of a center frequency of a frequency band received or transmitted by the antenna.

7. The antenna substrate according to claim 1,
wherein a plurality of the antennas are formed in an array shape on the first buildup layer, and
wherein the first through-hole via is arranged in at least one of antenna formation areas in a plan view viewed from the thickness direction.
